(19) United States
(12) Patent Application Publication
(10) Pub. No.: US 2012/0123728 A1
(43) Pub. Date: May 17, 2012

(54) TESTING AN ELECTRONIC DEVICE

(76) Inventors: Derek D. Perronne, Houston, TX (US); Robert D. Matthews, Sugarland, TX (US); Timothy G. Arn, The Woodlands, TX (US)

(21) Appl. No.: 13/386,295

(22) PCT Filed: Mar. 31, 2010
(86) PCT No.: PCT/US2010/029301

§ 371 Date: Jan. 20, 2012

(51) Int. Cl. G06F 19/00

(52) U.S. Cl. 702/119

(57) ABSTRACT

Disclosed embodiments relate to an electronic device including a processor and a machine-readable storage medium, which may include instructions for testing an electronic device, including instructions for executing an executable and instructions for signaling the executable to initiate a test on an electronic device. The machine-readable storage medium may also comprise instructions for receiving information from the executable about the test before the booting of an operating system on the electronic device and before the executable finishes executing.

### BACKGROUND

Electronic devices often contain various hardware and software components originating from multiple suppliers. If the electronic device experiences an issue, diagnostic tests may be run on each of the hardware or software components to determine which component may be the cause. In some cases, it may be desirable for the suppliers of the components to each control different aspects of a testing process. However, a testing system allowing collaboration between multiple parties may involve sharing proprietary information between them.

### BRIEF DESCRIPTION OF THE DRAWINGS

In the accompanying drawings, like numerals refer to like components or blocks. The following detailed description references the drawings, wherein:

FIG. 1 is a block diagram illustrating one example of a computing system.

FIG. 2 is a block diagram illustrating one example of protocols used for communicating between two executables.

FIG. 3 is a flow chart illustrating one example of a method for testing an electronic device.

FIG. 4 is a block diagram illustrating one example of a method for testing a video card associated with an electronic device.

### DETAILED DESCRIPTION

Electronic devices are typically composed of many hardware and software components. When an issue arises with an electronic device, a diagnostic testing system may test various components of the electronic device to determine its cause. In some cases, it may be desirable to allow one computer program to control some aspects of a test, such as when a test is run and how test results are displayed, and to allow another computer program to control other aspects of a test, such as the implementation details of a test itself. If the components are sold by separate parties, such a diagnostic testing system may involve sharing proprietary information between the separate parties. For example, a company selling a graphics controller used in a personal computer may not be willing to share certain details related to its diagnostic test with the seller of the personal computer, but the seller of the personal computer may want to exert some level of control over tests run on its computers. In addition, existing diagnostic testing systems in some cases involve preparing the electronic device for the test, for example, by booting an operating system prior to the test or installing certain drivers used in the test.

In one embodiment, a method for testing an electronic device allows a third party to run an executable directed to testing an electronic device. For example, an executable directed to testing an electronic device, instead of the computer code itself, may be shared between parties so that proprietary information is not be revealed. The computing environment before an operating system is booted may be a single threaded environment in which two application executables are typically capable of one way communication between each other such that one application may send a communication to the other application, but not vice versa. In one embodiment, a testing executable is compiled as a driver so that it may both receive communications from another executable and send communications to the other executable. For example, a management executable directed to the management of one or more tests may load a test executable and send communications to it, for example, a communication signaling the test executable to initiate a test on an electronic device. The test executable may launch a test on the electronic device and communicate information about the test results back to the management executable for the management executable to prepare for display to a user.

In one embodiment, a method for testing an electronic device is independent of an operating system, A protocol, such as a Unified Extensible Firmware Interface (UEFI) protocol, may be used to allow bidirectional communication between two executables prior to the booting of an operating system. The Unified Extensible Firmware Interface protocol is a protocol used in many computer Basic Input/Output Systems (BIOS) for controlling electronic processes prior to the booting of an electronic device's operating system, In some cases, the specifications for the Unified Extensible Firmware Interface protocol are released by the Unified Extensible Firmware Interface Forum. However, it may be extended to include additional protocols. In one embodiment, two executables are not aware of implementation details outside of the protocol methods used for communicating between them. The protocol methods, such as Unified Extensible Firmware Interface protocol methods, may be used to test an electronic device prior to the booting of an operating system and without installing special drivers or other programs.

Embodiments for testing an electronic device have advantages. For example, having a separate management and test executable allows the management executable to control how test results are displayed without knowledge of proprietary information regarding the test itself. A management executable may format information received from the test executable, such as the progress or success of a test, in a manner more easily understood by an end user. For example, a management executable may tailor the output for the type of user, such as a commercial or individual user. Using protocol methods to test an electronic device prior to the booting of an operating system allows for tests to run even if issues are so severe that the operating system is unable to boot. In addition, the operating system independent tests may be run on electronic devices with different types of operating systems.

Practical applications of embodiments include contexts where a third party would like to control diagnostic tests. For example, a personal computer vendor may want to create a test system incorporating test executables from vendors of different components of the computer even if the vendors prefer not to share their proprietary information. Receiving the test results from the third party test executables may allow the computer vendor to pinpoint the cause of an issue before providing costly replacements. In addition, a separate management and test executable may be used in cases where test information is not proprietary, but there is a desire to separate the testing aspect of a system from the end user portion of the system, for example, by creating multiple tests with results displayed to users in a consistent manner.

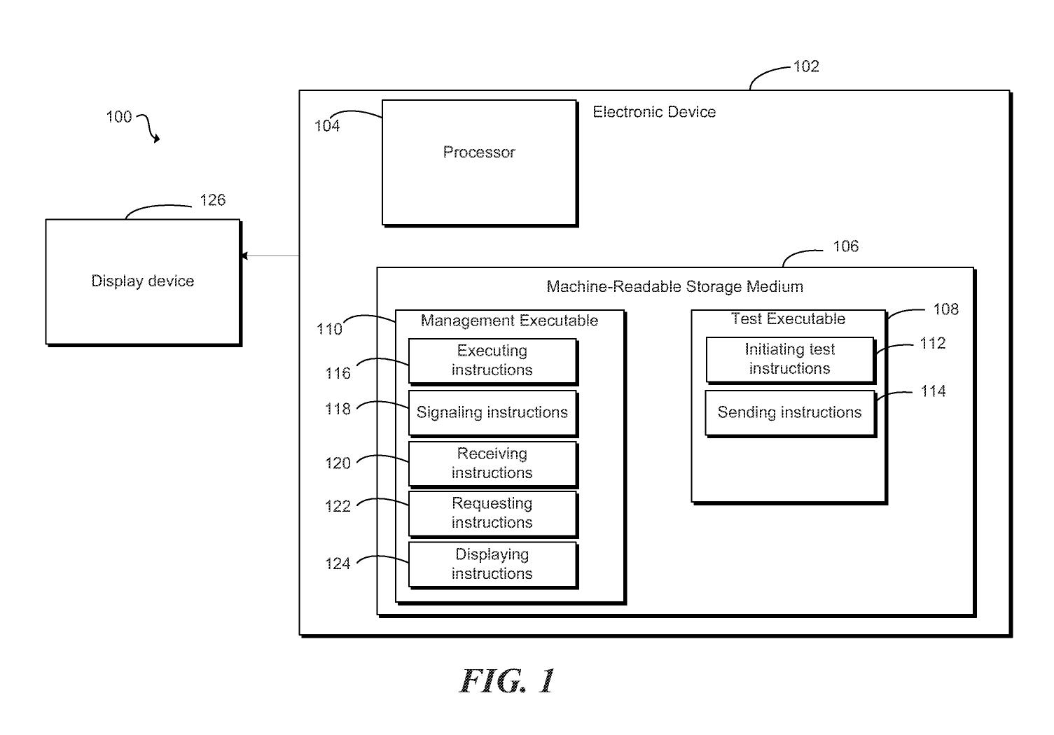

FIG. 1 is a block diagram illustrating one example of a computing system 100. The computing system 100 may include an electronic device 102, which may be any suitable electronic device, such as a personal computer or mobile phone. The electronic device 102 may be connected to a display device 126 that displays data generated by the electronic device 102. The display device 126 may be any suitable display device, for example, a monitor.

The electronic device 102 may include, for example, a processor 104 and a machine-readable storage medium 106. The processor 104 may be a central processing unit (CPU), a semiconductor-based microprocessor, or any other hardware device suitable for retrieval and execution of instructions stored in the machine-readable storage medium 106. The processor 104 may fetch, decode, and execute instructions.

The machine-readable storage medium 106 may be any electronic, magnetic, optical, or other physical storage device that stores executable instructions or other data (e.g., a hard disk drive, random access memory, flash memory, etc.). The machine-readable storage medium 106 may include, for example, a test executable 108 and a management executable 110. In one embodiment, the management executable 110 and the test executable 108 are capable of bidirectional communication such that the management executable 110 sends information to the test executable 108 and the test executable 108 sends information to the management executable 110.

The test executable 108 may include initiating test instructions 112 and sending instructions 114. The test executable 108 may, for example, execute the initiating test instructions 112 to initiate a test of the electronic device 102. The test executable 108 may execute the sending instructions 114 to send information about the test, such as the results of the test, to the management executable 110. In one embodiment, the test executable 108 is compiled as a driver, such as a boot services driver. This may allow the test executable 108 to launch a test and remain in memory to send data to other programs, such as the management executable 110, before and after launching the test.

The management executable 110 may include instructions such as executing instructions 116, signaling instructions 118, and receiving instructions 120. In one embodiment, the executing instructions 116 execute the test executable 108, the signaling instructions 118 signal the test executable 108 to launch a test on the electronic device 102, and the receiving instructions 120 receive information from the test executable 108 about the test initiated by the test executable 108. In one embodiment, the management executable 110 also includes displaying instructions 122 for determining a manner for displaying data on the display device 126 and requesting instructions 124 for requesting information from the test executable 108. In one embodiment, the management executable 110 is compiled as an application that launches the test executable 108.

In one embodiment, the test executable 108 and management executable 110 are installed on the electronic device 102, such as a personal computer. For example, a user with a computer issue may select a particular key or button to initialize the management executable 110 for diagnosing computer issues. In some implementations, the management executable 110 is initialized before the booting of an operating system on the electronic device 102.

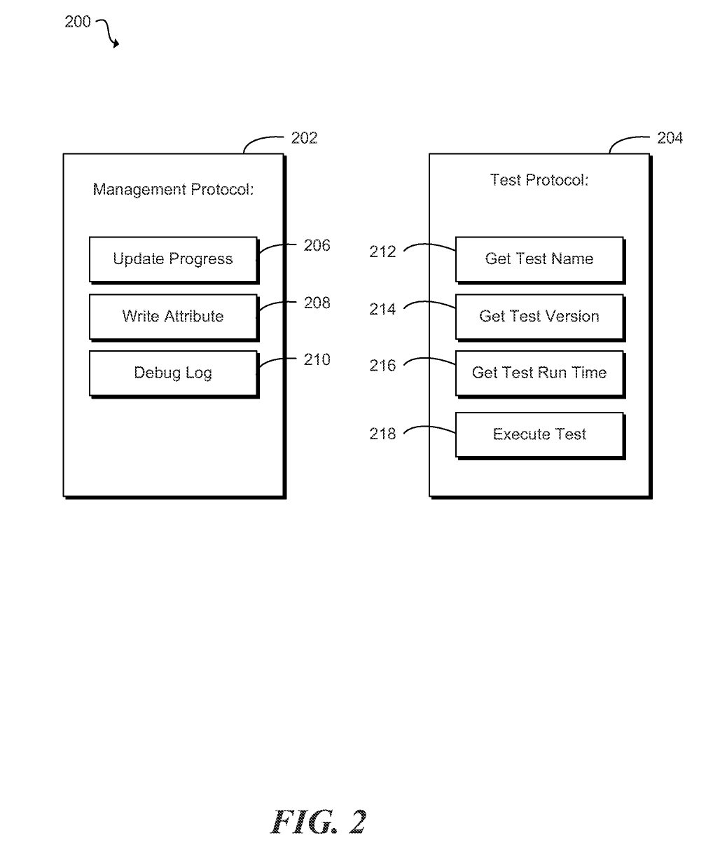

FIG. 2 is a block diagram illustrating one example of protocols used for communicating between two executables. For example, a management protocol 202 and a test protocol 204 may be used for communicating between the management executable 110 and the test executable 108. In one embodiment, the creator of the management executable 110 does not know the implementation details of the test protocol 204 and the creator of the test executable 108 does not know the implementation details of the management protocol 202.

In one embodiment, the management executable 110 and the test executable 108 provide a protocol to each other. For example, the management executable 110 may register a management protocol 202, and the test executable 108 may register a test protocol 204. Test executables created by different vendors may use the same test protocol 204. In one embodiment, a test protocol may differ for each test executable. For example, each test executable may provide different methods for use by the management executable 110 to communication with the test executable 108.

Any suitable protocol methods may be used to communicate between the management executable 110 and the test executable 108, and other protocol methods may be used instead of or in addition to those shown in FIG. 2. The test protocol 204 and the management protocol 202 may be any suitable protocol, such as a Unified Extensible Firmware Interface protocol, for communicating between executables prior to the booting of an operating system. In one embodiment, the management executable 110 communicates with the test executable 108 using both methods provided by a Unified Extensible Firmware Interface protocol and methods provided by a different protocol.

The management protocol 202 may include, for example, an update progress method 206, a write attribute method 208, and a debug log method 210. The test executable 108 may execute the update progress method 206 to send the management executable 110 information about the progress of a test. The test executable 108 may execute the write attribute method 208 to send information to the management executable 110 about an attribute of a test, such as a test value associated with a test attribute, and the test executable 108 may execute the debug log method 210 to send information to the management executable 110 to be added to a log of information used to debug an issue.

The test protocol 204 may include any suitable methods for allowing the management executable 110 to communicate with the test executable 108. For example, it may include a get test name method 212 for allowing the management executable to request the name of a test initiated by the test executable 108, a get test version method 214 for the management executable 110 to request version information about a test, a get test run time method 216 allowing the management executable 110 to request information about the length of time for a test to run, and an execute test method 218 for the management executable 110 to signal the test executable 108 to initiate a test on the electronic device 102.

In one embodiment, the test protocol 204 includes methods allowing the management executable 110 to send information to the test executable 108 with its request for information, such as in the form of a parameter for one of the methods of the test protocol 204. This may involve the creator of the management executable 110 being aware of some information about the particular test executable 108, such as the type of information to send to the test executable 108 as a parameter.

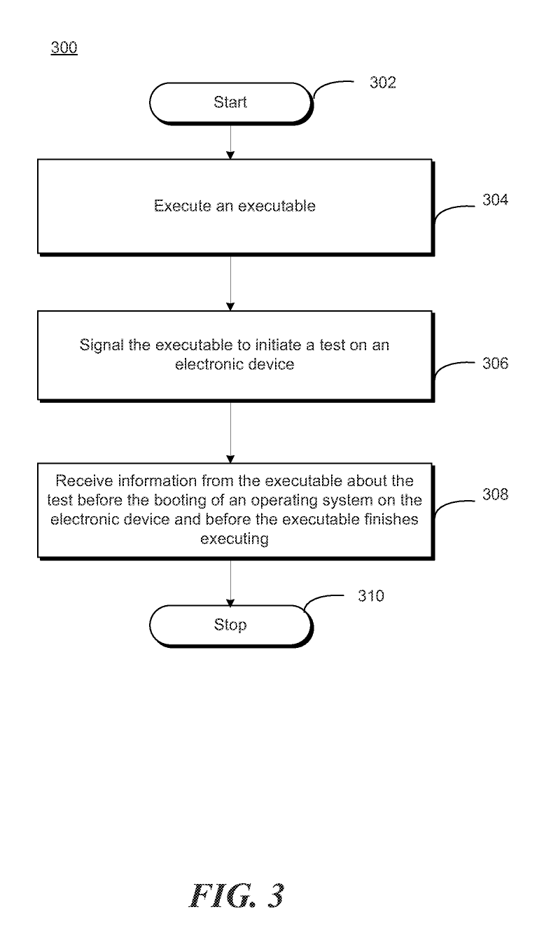

FIG. 3 is a flow chart illustrating one example of a method 300 for testing the electronic device 102 performed by the management executable 110. The management executable 110 may launch the test executable 108 and receive diagnostic test results from the test executable 108. In one embodiment, the management executable 110 then determines a manner for displaying information about the received test results on the display device 126.

Beginning at a block 302, the method continues to a block 304 where the processor 104, by executing the management executable 110 executing instructions 116, executes an executable. The executable may be executed prior to the booting of an operating system on the electronic device 102. The executable may be, for example, the test executable 108. The executing instructions 116 may call a method of the standard Unified Extensible Firmware Interface protocol, such as an Image protocol method, in order to load and execute the test executable 108.

In one embodiment, after executing the test executable 108, the management executable 110 executes the requesting instructions 124 to request information from the test executable. For example, referring to FIG. 2, the requesting instructions 124 may provide instructions to execute the get test name method 212, get test version method 214, or get test run time method 216 to request information about a test that may be run by the test executable 108. In one embodiment, the management executable 110 sends information to the test executable 108 with its request for information, for example, in the form of a parameter sent with a method.

Moving to a block 306, the processor 104 executes the management executable 110 signaling instructions 118 to signal the test executable 108 to initiate a test on the electronic device 102. For example, the management executable 110 may call a method of a protocol for communicating with the test executable 108, such as the execute test method 218, to signal the test executable 108 to initiate a test on the electronic device 102. In response, the processor may execute the test executable 108 initiating test instructions 112 to initiate a test on the electronic device 122, for example, a test to determine whether the electronic device 102 is functioning properly. The test may be any suitable test, such as a test on hardware equipment or a software program. The test executable 108 may be designed to test a single or multiple components of the electronic device 102. The test executable 108 may also run one or more tests on each of the electronic device components.

Continuing to a block 308, the management executable receives information from the test executable 108 about the test before the booting of an operating system on the electronic device 102 and before the test executable 108 finishes executing. The management executable 110 receiving instructions 120 may include instructions for receiving information from the test executable 108 through the management protocol 202. For example, the receiving instructions 120 may include instructions related to implementation details of the management protocol 202 methods. The receiving instructions 120 may include instructions for receiving the information via a Unified Extensible Firmware Interface protocol method, such as a method provided to the test executable 108.

The processor 104, such as by executing the test executable 108 sending instructions 114, may execute a management protocol 202 method to send information to the management executable 110 about the test. The information may be any information related to the test. The test executable 108 may execute the update progress method 206 to send information about the progress of the test, such as the time remaining to complete the test or the percentage of the test completed. In one embodiment, the test executable 108 sends progress information to the management executable 110 at a particular interval, such as a time period interval or a percentage completion interval.

The information sent by the test executable 108 and received by the management executable 110 may include information about defects found in the electronic device 102 during the test. The test executable 108 may send information about the test to the management executable 110 at any point. For example, the test executable 108 may send information about the test to the management executable 110 when a defect is found, at a defined interval, or at the completion of the test. The test executable 108 may send any suitable information about the results of a test, such as information about a test attribute and a test value to the management executable 110 by executing the write attribute method 208. For example, the test executable 108 may send an attribute about a video card memory and a value, such as 128 MB, to the management executable 110. In one embodiment, the test executable executes the debug log method 210 to send information to the management executable 110 about a defect found in the electronic device 102. The management executable 110 may create a debug file, such as an Extensible Markup Language (XML) file with the received information. In one embodiment, the test executable 108 writes defect information to a file readable by the management executable 110. The method 300 then continues to a block 310 and stops.

The processor 104, by executing the management executable 110 displaying instructions 122, may determine a manner for displaying information received from the test executable 108 on the display device 126. For example, the displaying instructions 128 may provide instructions to summarize received data or create graphical representations of it. The management executable 110 may tailor data based on additional factors, such as the type of customer viewing the data or the environment in which it is viewed. For example, the management executable 110 may determine to display data differently for a business electronic device than a consumer electronic device and to display data differently for an electronic device in an office setting than one in a factory setting. In one embodiment, the management executable 110 executes multiple test executables, each testing a different electronic device component or different aspect of an electronic device component. The management executable 110 may allow data from multiple types of tests from different vendors to be displayed to the user in a similar manner. In one embodiment, the management executable 110 determines that data related to a successful test should not be displayed on the display device 128.

Information about a test of the electronic device 102 may be displayed on the display device 126 by the management executable 110 or by another program in the manner determined by the management executable 110. Data about a test may be displayed on the display device 126 at any point. For example, data about the progress of a test may be displayed as it is received from the test executable 108. Data about defects may be displayed as they are received by the management executable 110, at the completion of the test, or at another time period. In one embodiment, information about a test is displayed on the display device 126 before an operating system is booted on the electronic device 102.

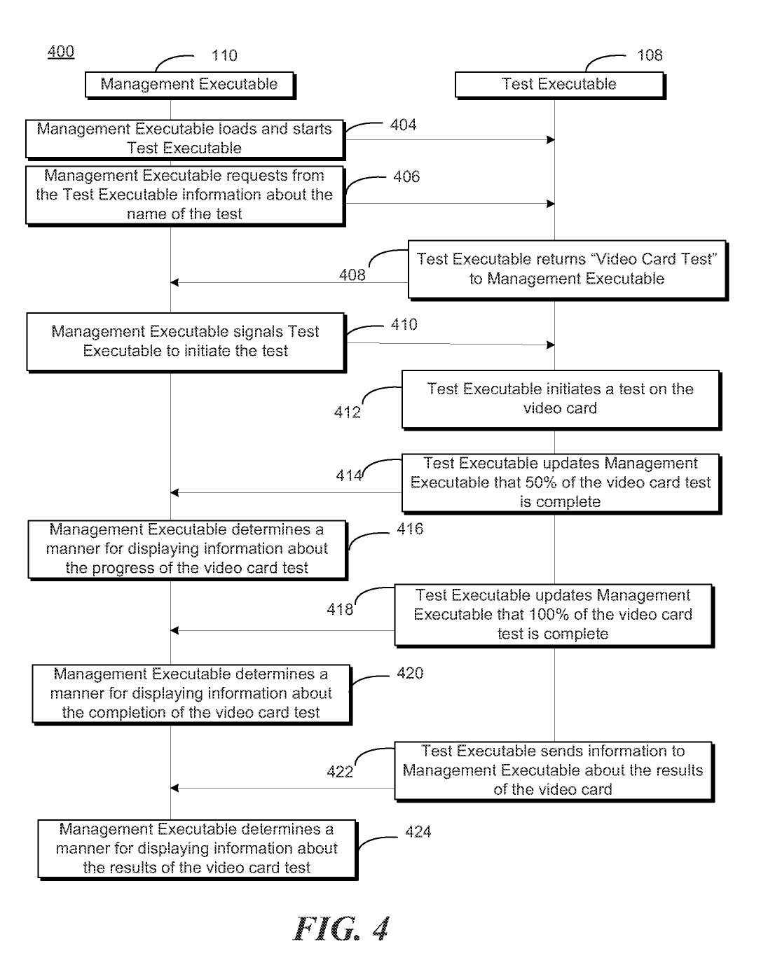

FIG. 4 is a block diagram illustrating one example of a method 400 for testing a video card associated with the electronic device 102. In some cases, a video card vendor may prefer not to share proprietary information with an electronic device vendor. Using two executables communicating via a protocol for communication prior to the booting of an operating system, such as a Unified Extensible Firmware Interface protocol, allows a test executable provided by a video card vendor and a management executable provided by an electronic device vendor to communicate with each other even if an operating system will not boot. For example, the management executable 110 and test executable 108 may communicate with the use of protocols known to each executable, such as the management protocol 202 and the test 204 shown in FIG. 2.

Beginning at a block 404, the management executable 110 loads and starts the test executable 108. Moving to a block 406, the management executable 110 requests from the test executable 108 information about the name of the test performed by the test executable 108. The management executable 110 may request the information, for example, by executing the get test name method 212 associated with the test protocol 204 shown in FIG. 2. Continuing to a block 408, the test executable 108 returns the name “Video Card Test” to the management executable 110. In one embodiment, the management executable 110 determines a manner for displaying data about the test name on the display device 126. Proceeding to a block 410, the management executable 110 signals the test executable to initiate the test on the video card, for example, by executing the execute test method 218. Moving to a block 412, the test executable 108 initiates a test on the video card.

Proceeding to a block 414, the test executable 108 updates the management executable 110 that 50% of the video card test is complete. Moving to a block 416, the management executable 110 determines a manner for displaying information about the progress of the video card test. The management executable 110 may display the information on the display device 126 or send it to another program for display.

Continuing to a block 418, the test executable 108 updates the management executable 110 that 100% of the video card test is complete, for example, by executing the update progress method 206 associated with the management protocol 202. Moving to a block 420, the management executable 110 determines a manner for displaying information to show that the video card test is complete, and the display data may be shown on the display device 126. Proceeding to a block 422, the test executable 108 sends information to the management executable 110 about the results of the video card test. For example, the test executable 108 may execute the write attribute method 208 or the debug log method 210 associated with the management protocol 202. The management executable 106 may then log the received information. Continuing to a block 424, the management executable 110 determines a manner for displaying information about the results of the video card test. The information may be displayed on the display device 126.

Some embodiments of a method for testing an electronic device are discussed above, but other embodiments are also contemplated. Embodiments provide many important advantages. Some embodiments allow for a testing system in which two executables may communicate with each other in a bidirectional manner in a single threaded pre-operating system environment. This may allow communication without sharing proprietary information between the creators of the two executables. In addition, some embodiments allow for an electronic device to be tested even if an operating system is unable to boot. Such a testing system may be useful in a troubleshooting context where it is desirable to control the display of testing information without controlling the details of the diagnostic tests.

1. A machine-readable storage medium encoded with instructions executable by a processor for testing an electronic device, the machine-readable medium comprising:
instructions for executing an executable;
instructions for signaling the executable to initiate a test on an electronic device; and
instructions for receiving information from the executable about the test before the booting of an operating system on the electronic device and before the executable finishes executing.

2. The machine-readable storage medium of claim 1, wherein the executable comprises an executable compiled as a driver.

3. The machine-readable storage medium of claim 1, further comprising instructions for determining a manner for displaying the received information.

4. The machine-readable storage medium of claim 1, further comprising instructions for requesting information from the executable.

5. The machine-readable storage medium of claim 4, further comprising instructions to pass a parameter to the executable when requesting information from the executable.

6. The machine-readable storage medium of claim 1, wherein the instructions for receiving information comprise a Unified Extensible Firmware Interface protocol method for receiving information.

7. A computing system, comprising:
a processor; and
a machine-readable storage medium encoded with instructions executable by the processor for testing an electronic device, the machine-readable medium comprising:
a test executable compiled as a driver; and
a management executable configured to:
execute the test executable prior to the booting of an operating system of the electronic device; and
communicate information to the test executable while the test executable is executing,
wherein the test executable is configured to:
initiate a test on the electronic device; and
communicate information to the management executable while the test executable is executing.

8. The computing system of claim 7, wherein the management executable is configured to communicate information to the test executable by executing a Unified Extensible Firmware Interface protocol method.

9. The computing system of claim 7, wherein the test executable is configured to communicate information to the management executable by executing a Unified Extensible Firmware Interface protocol method.

10. A method for testing an electronic device, comprising:
executing, by a management executable, a test executable;
signaling, by the management executable, the test executable to initiate a test on the electronic device;
initiating, by the test executable, a test on the electronic device; and
sending, by the test executable before the booting of an operating system on the electronic device and before the test executable finishes executing, information to the management executable about the test.

11. The method of claim 10, wherein sending information to the management executable comprises sending information to the management executable by executing a Unified Extensible Firmware Interface protocol method.

12. The method of claim 10, wherein the test executable comprises an executable compiled as a driver.

13. The method of claim 10, further comprising requesting information, management executable, about the test from the test executable.

14. The method of claim 13, further comprising sending, by the management executable, a parameter to the test executable when requesting information.

15. The method of claim 10, further comprising determining, by the management executable, a manner for displaying the information about the test sent by the test executable.
